(19) United States
(12) Patent Application Publication
(10) Pub. No.: US 2008/0302968 A1
(43) Pub. Date: Dec. 11, 2008

(54) CHARGED PARTICLE DETECTOR AND DETECTING APPARATUS UTILIZING THE SAME

(76) Inventors: Takahiro TADOKORO, Hitachi (JP); Kazuhiro Takeuchi, Hitachi (JP); Yukio Kawakubo, Hitachi (JP); Manabu Aoki, Hitachi (JP); Masaki Matsumoto, Hitachinaka (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/186,834

(22) Filed: Aug. 6, 2008

Related U.S. Application Data
(63) Continuation of application No. 10/859,225, filed on Jun. 3, 2004.

(30) Foreign Application Priority Data
Jun. 10, 2003 (JP) 2003-164950
May 21, 2004 (JP) 2004-151150

(51) Int. Cl. G01T 1/20

(52) U.S. Cl. 250/361 R

(57) ABSTRACT

In a charged particle detector, the vacuum barrier can be reduced in size and a multichannel configuration is possible. A charged particle detector includes a metallic frame having one or more holes formed therein, a light transmitting member fixed in each of the holes of the metallic frame, an inorganic scintillation element fixed on a surface of the light transmitting member, the surface being on a first side of the member; and a photodetector disposed on a surface of the light transmitting member, the surface being on a second side opposing the first side of the member. Charged particles having passed through the inorganic scintillation element are sent via the light transmitting member to the photodetector and are detected by the photodetector.

This application is a continuation application of U.S. application Ser. No. 10/859,225, filed on Jun. 3, 2004, the entirety of which is incorporated herein by reference.

### INCORPORATION BY REFERENCE

The present application claims priority from Japanese application JP 2003-164950 filed on Jun. 10, 2003, the content of which is hereby incorporated by reference into this application.

### BACKGROUND OF THE INVENTION

The present invention relates to a charged particle detector to detect charged particles and a detecting apparatus including the detector.

The charged particle detectors includes a gas detector, a semiconductor detector, an organic scintillation detector, and an inorganic scintillation detector.

The inorganic scintillation detector includes, as described in, for example, JP-A-2001-183464, a scintillator which is a substance to emit fluorescence when charged particles enter therein and a device to convert the fluorescence into an electric signal.

In a recent detecting apparatus to detect explosives and prohibition drugs using, for example, neutrons generated by a fusion reaction between deuterium and tritium, it is required to detect alpha rays generated by the fusion reaction to identify an explosive and/or a prohibition drug. The inorganic scintillation element or device to detect alpha rays emits a small quantity of light. Therefore, the photodetector to detect the alpha rays includes a photoelectric multiplier having a function to amplify detected light.

To measure charged particles in a vacuum by use of an inorganic scintillation element, the element is disposed in the vacuum. Since the photoelectric multiplier cannot be used in a vacuum, it is required to place the multiplier in an atmospheric environment. Therefore, a vacuum barrier to sufficiently pass therethrough light having a wavelength of light emitted from the inorganic scintillation element is employed. The vacuum barrier includes a combination of glass and a metal having a small linear expansion coefficient such as cobar, the metal and the glass being fused or molten to be tightly fixed to each other. However, the conventional vacuum barrier is attended with a problem that the detector is large in its size. In the charged particle detector for use with the explosive and prohibition drug detecting apparatus, a multichannel configuration is required to measure positions of charged particles. However, when the vacuum barrier has a large size, it is difficult to implement such a multichannel configuration.

### SUMMARY OF THE INVENTION

It is therefore an object of the present invention to provide a charged particle detector in which the vacuum barrier is reduced in size to thereby allow the multichannel configuration.

To achieve the object in accordance with the present invention, there is provided a dangerous substance detecting apparatus including a metallic frame having one or more holes formed therein, a light transmitting member fixed in each of the holes of the metallic frame, an inorganic scintillation element fixed on a surface of the light transmitting member, the surface being on a first side of the member; and a photodetector disposed on a surface of the light transmitting member, the surface being on a second side opposing the first side of the member. Fluorescence generated by charged particles having entered the inorganic scintillation element is sent via the light transmitting member to the photodetector and is detected by the photodetector.

In accordance with the present invention, there is provided a detecting apparatus, including a charged particle detector including a metallic frame having one or more holes formed therein, a light transmitting member fixed in each of the holes of the metallic frame, an inorganic scintillation element fixed on a surface of the light transmitting member, the surface being on a first side of the member; and a photodetector disposed on a surface of the light transmitting member, the surface being on a second side opposing the first side of the member; a neutron generator for generating charged particles and neutrons, and a gamma ray detector for detecting gamma rays emitted when the neutrons are radiated onto an inspection object. According to a result of detection by the charged particle detector and a result of detection by the gamma ray detector, elements of the inspection object are identified and thereby detecting an explosive.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram showing an example of a metallic frame and glass fixed thereonto.

FIG. 2 is a schematic diagram showing another example of a metallic frame and glass fixed thereonto.

FIG. 3 is a schematic diagram showing still another example of a metallic frame and glass fixed thereonto.

FIG. 4 is a schematic diagram showing further another example of a metallic frame and glass fixed thereonto.

FIG. 5 is a schematic diagram showing also another example of a metallic frame and glass fixed thereonto.

FIG. 6 is a diagram showing an example of a working process of an inorganic scintillation element and a metallic frame.

FIG. 7 is a diagram showing an example of a charged particle detector.

FIG. 8 is a diagram showing another example of a charged particle detector.

FIG. 9 is a diagram showing an example of use of a charged particle detector.

FIG. 10 is a block diagram showing an example of a configuration of a detecting apparatus including a charged particle detector.

FIG. 11 is a block diagram showing another example of a configuration of a detecting apparatus including a charged particle detector.

FIG. 12 is a block diagram showing further an example of a configuration of a detecting apparatus including a charged particle detector.

FIG. 13 is a block diagram showing still another example of a configuration of a detecting apparatus including a charged particle detector.

### DESCRIPTION OF THE EMBODIMENTS

Referring now to the drawings, description will be given of an embodiment in accordance with the present invention.

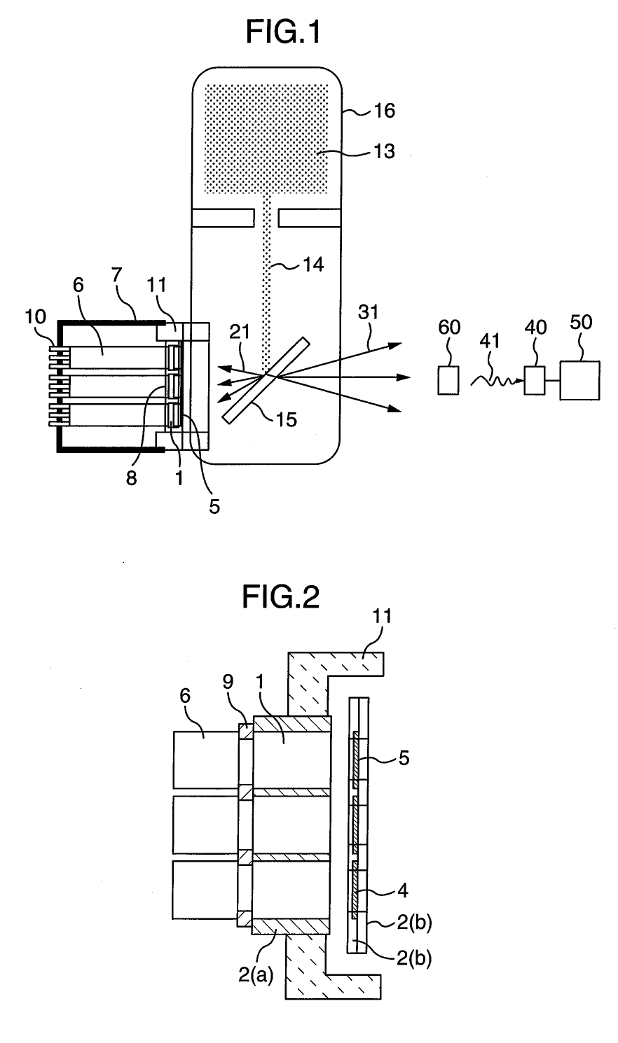

FIG. 1 shows an embodiment a charged particle detector used with a neutron generator. A flange attaching metallic member or frame 11 is beforehand arranged on a side surface of a neutron generating tube 16. The metallic frame 11 is fixed onto the side surface of the tube 16 by welding or by use of bolts. The tube 16 contains plasma of deuterium 13 and a hydrogen occluding alloy 15. An ion beam of deuterium 15 drawn from the plasma 13 collides with the alloy 15 having occluded tritium. As a result of fusion reaction between deuterium and tritium, alpha rays 21 and neutrons 31 are generated. Since the alpha rays 21 and the neutrons 31 respectively travel in almost opposite flight directions, namely, in the respective directions with an angular difference of about 180° therebetween. Therefore, by identifying creation positions and detection positions of the alpha rays 21, the travelling directions thereof are known and are hence can be identified.

Using two-dimensional information of the flight direction of the neutrons 31 and one-dimensional information of flight time thereof, a signal processor 50 can obtain three-dimensional information. Gamma rays 41 emitted from an inspection object 60 are detected by a gamma ray detector 40. Using the result of detection, the signal processor 50 identifies energy and a count value of the gamma rays 41. Therefore, for example, using (a count value of nitrogen/a count value of oxygen) and (a count value of carbon/a count value of oxygen), the signal processor 50 can identify composition of the inspection object 60. By additionally using the three-dimensional information, the signal processor 50 can recognize a contour of the identified object such as an explosive or a prohibition drug to display the contour on a display device.

By simultaneously identifying the alpha rays 21 and the gamma rays 41 generated as a result of the reaction between the neutrons 31 and the inspection object 60, background noise can be eliminated. A light shield container 7 is at an atmospheric pressure and the neutron generating tube 16 is at 10⁻¹ pascal (Pa) or less. Alpha rays from the alloy 15 travel through the tube 16 and a light shield metallic film 5 made of aluminum, nickel, or a chromium-molybdenum alloy and enter an inorganic scintillation element 4. As a result, the element 4 emits fluorescence. The fluorescence passes through glass 1 and a glass window for photoelectric surface 8 and reaches a photoelectric surface of a photoelectric multiplier 6. The photoelectric surface converts the fluorescence into electrons and then the photoelectric multiplier 6 amplifies the electrons to attain an electric signal. The signal is fed through an insulator terminal 10. By measuring a peak value of the signal, energy of the alpha rays is obtained. The neutron generating tube 16 may be a device to generate charged particles and neutrons through a fusion reaction (D-D reaction) between deuterium.

Referring next to FIG. 2, description will be given of an example of a charged particle detector in the embodiment. One or more thin disk-shaped inorganic scintillation elements 4 are sandwiched between fixing plates 2(b) made of metal or ceramics. Each element 4 has a surface beforehand sputtered or processed by evaporation such that a light shield surface 5 is formed thereon using aluminum, nickel, or a chromium-molybdenum alloy to shield the element 4 from light. Each of the fixing plates 2(b) has holes in association with the scintillation elements 4 so that light of fluorescence from the element 4 reaches the glass 1. The plates 2(b) are installed such that the elements 4 correspond to the associated glass sections 1. On the atmospheric-pressure side of the glass 1, photoelectric multipliers 6 are disposed with insulator plates 9 therebetween such that the glass sections 1 corresponds to the photoelectric multipliers 6 associated therewith. When it is required to heat the charged particle detector, the photoelectric multipliers 6 and the insulator plates 9 are removed before the heating process and are again installed after the heating process.

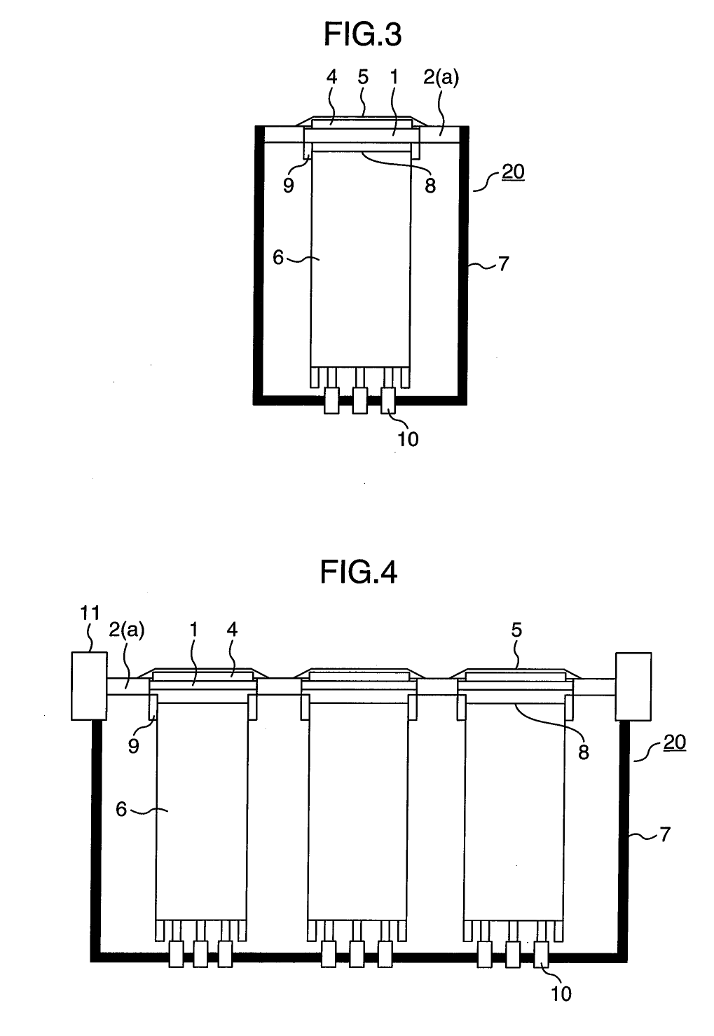

FIG. 3 shows another example of a charged particle detector 20 in the embodiment.

The charged particle detector 20 includes a photoelectric multiplier 6 arranged in a light shield container 7.

A vacuum barrier is arranged between the container 7 and a neutron generating tube 6. The barrier includes a metallic frame 2 made of a material such as aluminum and glass 1 which is fixed on the frame 2 and which has a light transmitting characteristic. The glass 1 is fixed on the frame 2(a) in association with a section of a light passing window of the photoelectric multiplier 6. The glass 1 has one side facing the vacuum side, namely, the side of the neutron generating tube 6. The other side, i.e., the atmospheric-pressure side of the glass 1 is tightly fixed onto a surface of glass for photoelectric surface placed at an end surface of the photoelectric multiplier 6 using optical grease or cement. By using aluminum for the metallic frame 2, the secondary emission of gamma rays can be reduced because aluminum is a substance not easily activated.

The metallic frame 2 has holes. With each of the holes, the glass 1 having a contour associated with the hole is engaged.

A side surface of the glass 1 is coated with silicon resin or epoxy resin to tightly fix the glass 1. Therefore, when the glass is engaged with the hole of the metallic frame 2, the glass is tightly fixed in the hole. The glass 1 is installed such that one side thereof is on the vacuum side and the other side opposing the side is on the atmospheric side. As a result, stress caused by the pressure associated with the vacuum and the atmospheric pressure is received by a surface formed by the metallic frame 2 and the glass 1, and hence there is implemented a vacuum seal using the silicon resin or epoxy resin. In place of glass, synthetic quartz may also be employed in the configuration. That is, any light transmitting or passing member having a characteristic to pass light generated by the scintillation element 4 may be adopted as a member attached onto the metallic frame 2. Moreover, in place of the metallic frame 2, a frame made of glass may be utilized. The glass 1 includes a surface on which a thin-film inorganic scintillation element 4 is fixedly attached. The element 4 is formed using a crystalline yttrium-aluminum-oxygen compound with cerium added thereto (YA10₃), a crystalline lutecium-silicon-oxygen compound (Lu₂(SiO₄)O), cerium fluoride (CeF₃), barium fluoride (BaF₂), or gadolinium silicate (Gd₂SiO₅) with cerium added thereto. Using such an inorganic scintillation element 4, the count rate is increased to a high value equal to or more than 10⁵ per second and time resolution is improved to at most one nanosecond. The surface of the element 4 is coated with a thin light shield film 5 to shield the element 4 from light.

After the scintillation element 4 is attached onto the glass 1, the photoelectric surface 8 of the photoelectric multiplier 6 is fixed on a surface of the glass 1 using optical grease or cement or is fixed thereon with the insulator member 9 therebetween, the surface of the glass 1 opposing the surface coated with the metallic film 5. To prevent light other than the fluorescence generated from the element 4 in response to charged particles incident thereto from entering the photoelectric multiplier 6, the multiplier 6 is inserted into the shield container 7. On a bottom surface of the container 7, insulator terminals 10 are disposed to apply a high voltage to the photoelectric multiplier 6 and to obtain a signal therefrom. Charged particles pass through the shield metallic film 5 and enter the inorganic scintillation element 4. The element 4 then emits fluorescence. The fluorescent travels through the glass 1 and the glass window for photoelectric surface 8 and reaches the photoelectric surface of the photoelectric multiplier 6. The surface converts the fluorescence into electrons. The electrons are amplified by the multiplier 6 into an electric signal. The signal is fed through the insulator terminal 10. By measuring a peak value of the signal, energy of the charged particles is determined.

Although not shown, three insulator terminals 10 are respectively connected to a signal line for timing, a peak-value signal line, and a high-voltage applying line.

When the charged particles enter the inorganic scintillation element 4, electrons in the element 4 move from the valence band to the conduction band. Holes appear in the valence band. In some cases, energy given to the electrons is not sufficiently for the electrons to move to the conduction band. The electrons are kept electrostatically stayed in the associated holes in the valence band. Such an electron-hole pair is called an exciton. After the element 4 captures excitons or successively captures electrons and holes to enter an excited state, the element 4 emits fluorescence when the element 4 returns to the ground state. The quantity of fluorescence is almost proportional to the energy of charged particles with a proportion coefficient associated with the kind of the charged particles. Therefore, the energy can be measured by converting the fluorescence into an electric signal and by amplifying the signal by, for example, the photoelectric multiplier 6. However, when any visible light enters the scintillation element 4 in addition to the charged particles, the light also enters the photoelectric multiplier 6. As a result, the amplification and the photoelectric conversion take place. To prevent this adverse phenomenon, it is required to shield the inorganic scintillation element 4 from light such that the element 4 passes the charged particles and prevents passage of such light. For this purpose, the surface of the element 4 is coated with a thin metallic film made of aluminum, nickel, a chromium-molybdenum alloy, or the like. In the element 4, the peak value for heavy charged particles such as alpha rays is lower than that for gamma rays or electron beams when these rays are substantially equal in energy to each other. When the thickness of the element is reduced to a value almost equal to the range of the inorganic scintillation element 4 for the energy of alpha rays to be measured, high-energy alpha rays or electron beams are passed through the element almost without reducing the energy. It is therefore possible to detect heavy charged particles such as alpha rays in an environment of the gamma-ray background. A plurality of holes are bored in a glass or metallic plate. Each hole has a contour in which an upper surface is larger in its area than a lower surface such as a frustum of pyramid or a frustum of right circular cone. A glass member similarly having a contour with an upper surface larger in its area then a lower surface such as a frustum of pyramid or a frustum of right circular cone is inserted in each of the holes to be fixed therein using silicon resin or epoxy resin. In this structure, stress caused by the pressure associated with the vacuum and the atmospheric pressure can be received by a surface formed by the metallic frame and the glass surface. Therefore, a vacuum seal is achieved using the silicon or epoxy resin. The detector can be constructed in a multichannel configuration while reducing its size to conduct measurement with high positional resolution. By employing a metal almost equal in the line expansion coefficient to the glass for the metallic frame and by melting the glass to be fixed onto each hole of the metallic plate to form a fused junction, the multichannel detector can be implemented in a small-sized configuration. Therefore, the measurement can be carried out with high positional resolution.

FIG. 4 shows another example of a charged particle detector of the embodiment. After the inorganic scintillation elements 4 are fixed and then thin-film work is conducted as described above, a plurality of glass members 1 are tightly fixed onto glass fixing metallic plate 2(a) having a plurality of holes in a two-dimensional array. A metallic frame 11 is beforehand attached to the plate 2(a) to mount a vacuum container. The metallic frame 11 is required to be attached to the vacuum container such that the state of vacuum is not destroyed at the junction between the flange attaching frame 11 and the metallic plate 2(a) when the frame 11 is mounted on the vacuum container. On the side of the element 4 of the metallic frame 2(a) fixed onto the metallic frame 11, a metallic film 5 is formed by sputtering or evaporation using aluminum, nickel, or a chromium-molybdenum alloy. On a surface of the glass 1 opposing the film forming surface thereof, a glass surface for photoelectric surface 8 of each photoelectric multiplier 6 is fixed using optical grease or cement or is fixed using optical grease or cement with insulator members 9 therebetween. The side surface of the photoelectric multiplier 6 is shielded from light to possibly prevent fluorescence incident to other photoelectric multipliers 6 from entering the pertinent photoelectric multipliers 6. By arranging the inorganic scintillation elements 4 in a two-dimensional array, positions of charged particles incident thereto can be identified.

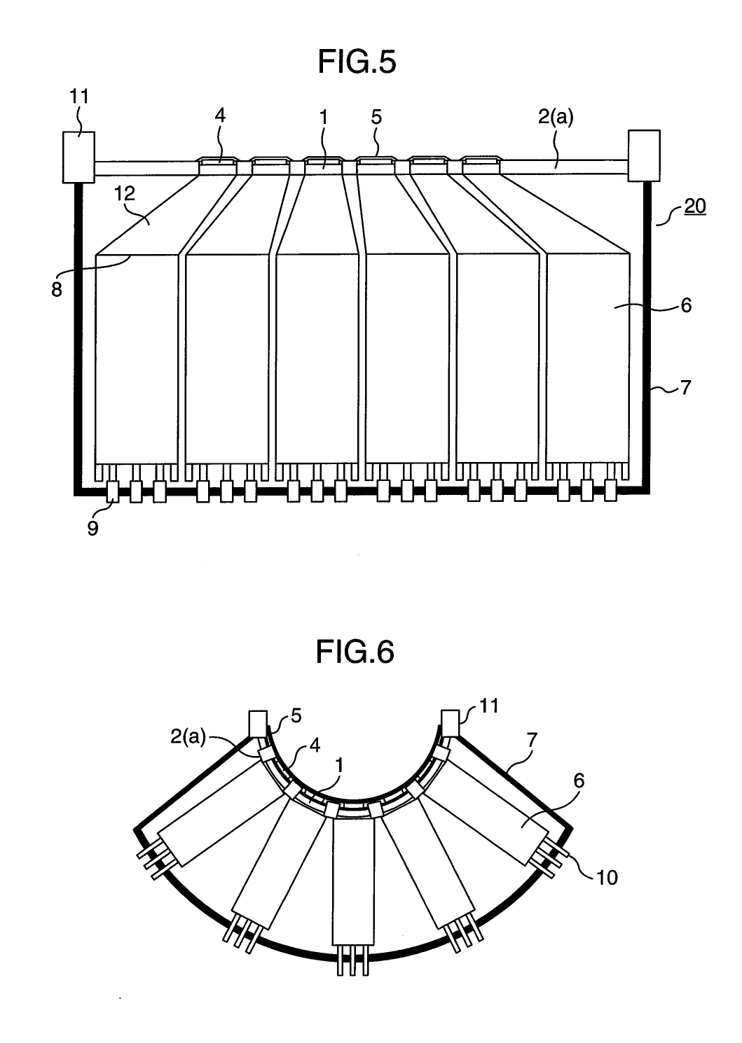

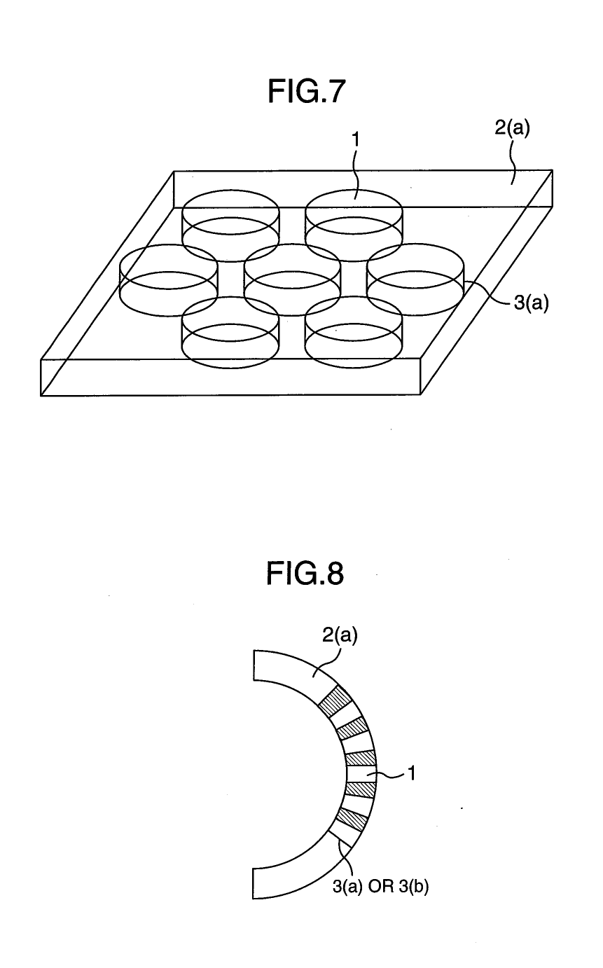

FIG. 5 shows another example of a charged particle detector used in the embodiment. As shown in FIG. 7, the inorganic scintillation elements 4 are disposed in a two-dimensional array. On a surface of the glass 1 opposing each element 4, an optical guide 12 having a side surface shielded from light by optical grease or cement is fixed. On a surface of the guide 12 opposite to the fixing surface between the guide 12 and the glass 1, the glass window for photoelectric surface 8 of the photoelectric multiplier 6 is tightly fixed using by optical grease or cement, the glass window 8 similarly having a side surface shielded from light. When the glass window 8 of the multiplier 6 is sufficiently larger in size than the inorganic scintillation element 4, the optical guide 12 is adopted to efficiently transport fluorescence from the element 4 to the photoelectric multiplier 6.

FIG. 6 shows further another example of a charged particle detector employed in the embodiment. As can be seen from FIG. 4, the glass fixing metallic plate 2(a) is constructed in a semispherical shape. A flange attaching metallic plate 11 on which the vacuum container can be attached is beforehand fixed onto an end surface of the metallic plate 2(a). As in FIG. 7, it is required that the state of vacuum is not broken at the junction between the metallic plate 11 and the metallic plate 2(a) when the vacuum container is attached. In the semispherical metallic frame 2(a) attached fixed to the metallic plate 11, a plurality of holes are bored in a two-dimensional array. The inorganic scintillation element 4 is fixed onto each of the holes in the semispherical surface. The glass member 1 undergone a thin-film work process is attached onto each element 4 to be fixed thereonto. On a surface of the glass 1, a metallic film 5 is formed by sputtering or evaporation to shield the glass 1 from light using aluminum, nickel, or a chromium-molybdenum alloy. For each of the elements 4, the glass surface for photoelectric surface 8 of the photoelectric multiplier 6 is fixed onto a surface of the glass 1 opposing the film forming surface by use of optical grease or cement. The side surface of each photoelectric multiplier 6 is shielded from light to possibly prevent the fluorescence incident to other photoelectric multipliers 6 from entering the pertinent photoelectric multiplier 6. The inorganic scintillation elements 4 are disposed in the two-dimensional array in the semispherical surface. Therefore, when charged particles are generated from one fixed point, the elements 4 can be installed at positions substantially equal in distance from the point.

Referring next to FIG. 7, description will be given of a manufacturing process of the vacuum barrier including the inorganic scintillation element for use with the charged particle detector 10 in the embodiment.

FIG. 7 shows another example of a junction between the glass fixing metallic plate 2(a) and the glass 1 in the embodiment. One or more cylindrical holes is or are bored in the plate 2(a). The glass 1 formed in a cylindrical shape is inserted into each of the holes. While heating the glass, pressure is applied to a top surface and the bottom surface thereof such that a side surface of the cylindrical hole of the metallic plate 2(a) is fixed onto a side surface of the cylindrical glass by fused junction. The line expansion coefficient of a material changes according to a change in temperature. In this case, the materials of the glass and the metallic plate are so selected that they are substantially equal in the line expansion coefficient to each other up to a temperature range in which the fused junction is formed by the cylindrical glass. For example, when boron-silicated glass is selected for the glass cylinder and an iron-nickel-cobalt alloy is used for the metallic frame, the glass cylinder and the metallic frame are almost equal in the line expansion coefficient to each other in a temperature range from the room temperature to the softening point of glass, i.e., about 800° C. In this situation, a temperature cycle of heating and cooling processes in the production does not cause problems such as cracks in the glass and pealing between the glass and the metal. In place of a cylindrical hole, there may be disposed a hole having a contour of a frustum of right circular cone, a frustum of pyramid, or a regular prism. It is also possible to coat the side surface of the glass 1 having a contour associated with the hole prepared in the glass fixing metallic plate 2(a) with silicon resin or epoxy resin 3(a) to insert the glass 1 into each hole of the metallic plate 2(a).

FIG. 8 shows further another example of junction between the glass fixing metallic plate 2(a) and the glass 1 in the embodiment. In the semispherical plate 2(a), holes are bored. Each hole has a contour of a frustum of right circular cone or pyramid. A surface of the glass 1 formed in a contour associated with the contour of the hole is coated with silicon resin or epoxy resin 3(a) and is inserted into each of the holes of the metallic plate 2(a). Or, in the metallic plate 2(a), there are bored holes each having a cylindrical contour or a rectangular prism. The glass 1 is buried in each hole. While heating the glass 1, pressure is applied to a top surface and a bottom surface thereof such that a side surface of the hole of the metallic plate 2(a) is fixed onto a side surface of glass 1 by fused junction.

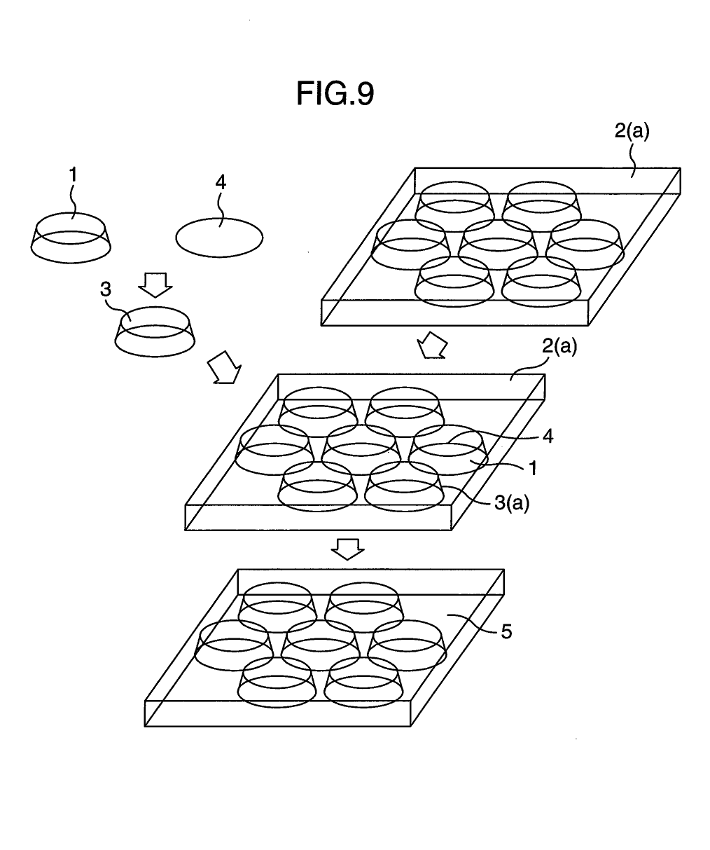

FIG. 9 shows an embodiment of a working process of the inorganic scintillation element 4 and the glass fixing metallic plate 2(a). First, the inorganic scintillation element 4 is fixed onto the glass 1 formed in a frustum of right circular cone using silicon resin or epoxy resin 3(a). The element 4 is polished into a thin-film shape. The element 4 may be fixed onto the glass 1 after the polishing process. The element 4 has a thickness substantially equal to the range of charged particles in the film. Next, a plurality of holes each having a contour of a frustum of right circular cone are bored in the glass fixing metallic plate 2(a). A surface of the glass 1 fixed with the element 4 is coated with silicon resin or epoxy resin 3(a). The glass 1 is engaged into each hole of the metallic frame 2. The side of a smaller end surface of the glass 1 faces the vacuum side and the side of a larger end surface of the glass 1 faces the atmospheric-pressure side. In this structure, stress caused by the pressure associated with the vacuum and the atmospheric pressure is received by a surface of the glass or a surface formed by the metallic plate and the glass, and a vacuum seal can be implemented using the silicon or epoxy resin. Next, a metallic film 5 is grown on the thin inorganic scintillation element 4 using aluminum, nickel, or a chromium-molybdenum alloy. It is required that the film 5 has a thickness sufficiently less than the range for energy of heavy charged particles such as alpha rays to be detected and a shielding characteristic sufficient to serve as a light shield film. Therefore, to use aluminum for the light shield film of a detector to detect alpha rays having an energy value of about 3.5 mega electron volts (MeV), the thickness of the film is required to be in a range from about one micrometer to about two micrometers. Similarly, to use a chromium-molybdenum alloy under the same condition, the thickness is required to range from about 300 nanometers to about 600 nanometers. This also applies when the metallic film 5 is grown by evaporation.

Next, description will be given of an example an explosive or prohibition drug detecting apparatus including a charged particle detector according to the present invention.

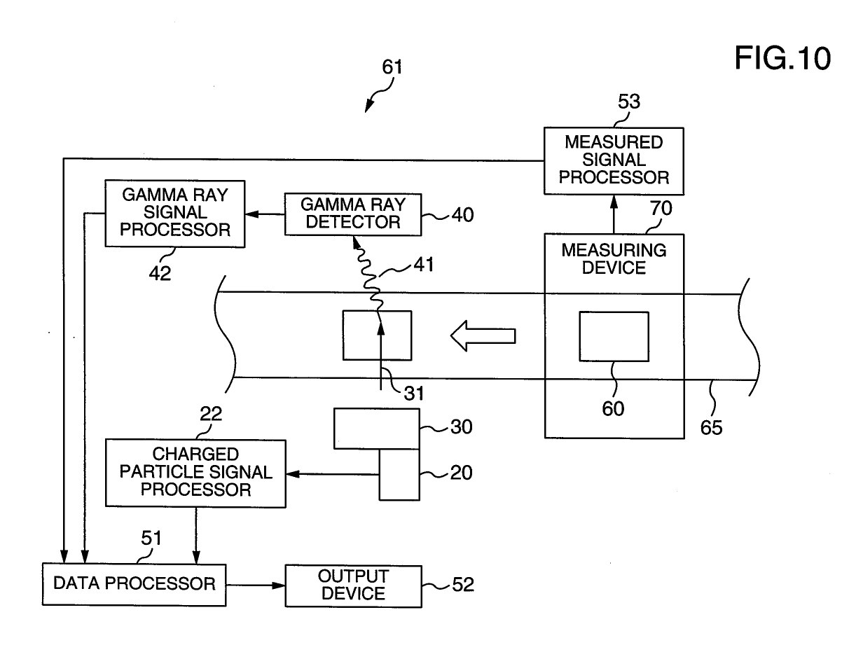

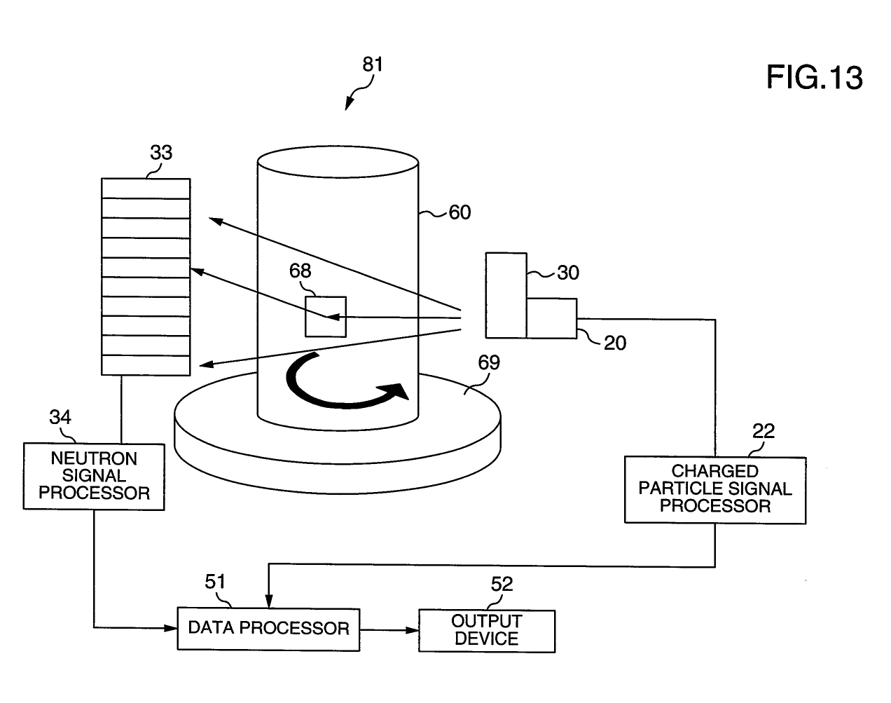

FIG. 10 shows a configuration of an explosive or prohibition drug detecting apparatus 61. In the apparatus 61, neutrons are radiated onto the inspection object 60. As a result, gamma rays 41 are isotropically generated from the object 60. By detecting a value of energy of the gamma rays, elements of the object is identified. The apparatus 61 includes a charged particle detector 20, a charged particle signal processor 22 to process signals from the detector 20, a neutron generator 30, a gamma ray detector 40 to detect gamma rays, a gamma ray signal processor 42 to process signals from the detector 40, a measured signal processor 53, a data processor 51 to process data from the processors 22, 42, and 53, and an output device 52 to display results of the processing. The apparatus 61 further includes a controller, now shown, to control overall operation of the apparatus 61. The apparatus shown in FIG. 13 measures a position, a size, and a contour of the inspection object 60 on a conveyor 65 before radiating neutrons thereonto. When the object 60 is a large object such as a container, a measuring device 70 such as an x-ray transmission apparatus or an x-ray computed tomography (CT) measures the contour and the density of a substance in the container to conduct inspection using neutrons in a range in which a substance equal in density to an explosive or a prohibition drug exists. It is therefore possible to cope with a case when the detecting apparatus using neutrons has a narrow range of inspection objects.

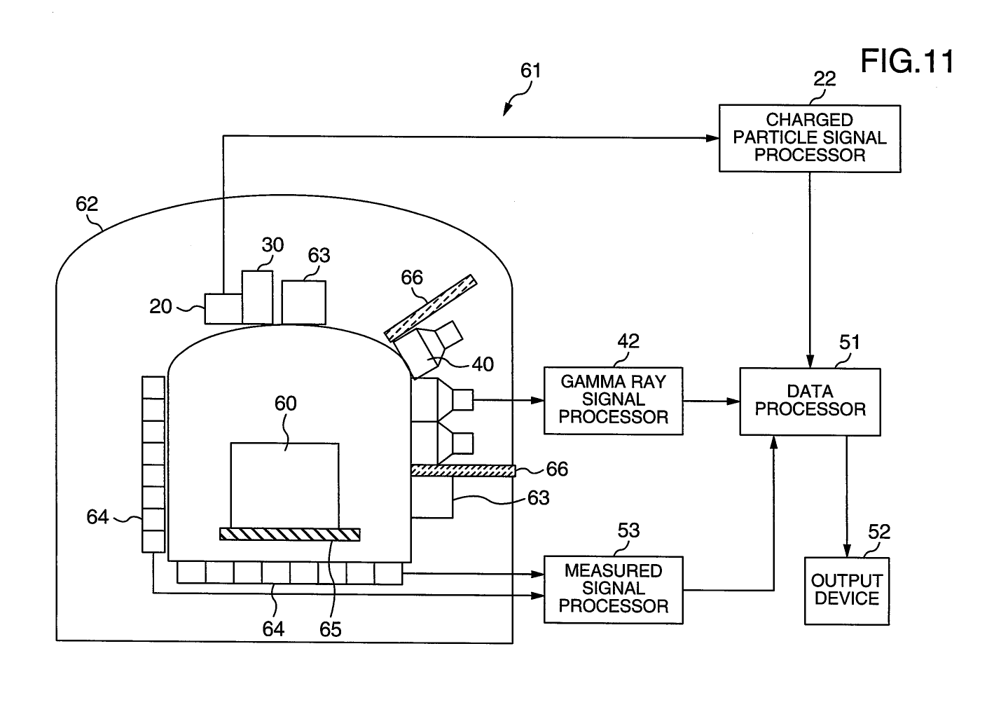

FIG. 11 shows another embodiment of an explosive or prohibition drug detecting apparatus 61 including the charged particle detector 20. A neutron generator 30, a gamma ray detector 40, an x-ray generator 63, and an x-ray detector array 64 to attain a density distribution and a contour distribution of an inspection object 60 are arranged in a cross section vertical to a transporting direction of the object 60. The apparatus 61 is comprehensively controlled by a controller, not shown. In a cross section of an apparatus wall 62 also serving as a light shield wall against radiation, the x-ray generator 63 and the x-ray detector array 64 are disposed. Similarly, a neutron generator 30 and a plurality of gamma ray detectors 40 are arranged. X-rays from the generator 63 pass through the inspection object 60 such as a luggage or a container and are measured by the detector array 64 to resultantly obtain an image using x-rays having passed through the object. The x-ray detector array 64 is a one-dimensional array. By transporting the object 60, the array 64 can produce a two-dimensional image. By operating two x-ray detector arrays 64 respectively oriented in two different directions, two images viewed in two directions can be obtained at the same time. In the apparatus 61, the processor 22 processes signals from the charged particle detector 20 and the processor 42 processes signals from the gamma ray detector 40. The processor 53 processes signals from the array 64 to produce a transmitted x-ray image of the object 60. The data processor 51 conducts operations of energy spectral of gamma rays and processes images to display an image on the output device 52. In the apparatus 61, the constituent components arranged in one plane produce a transmitted x-ray image and a neutron CT image almost at the same time. Therefore, the apparatus can be reduced in size. An explosive or a prohibition drug can be detected at a high speed.

Next, description will be given of an example in which the charged particle detector 20 and the neutron generator 30 are used to analyze constituent elements of an object in piping.

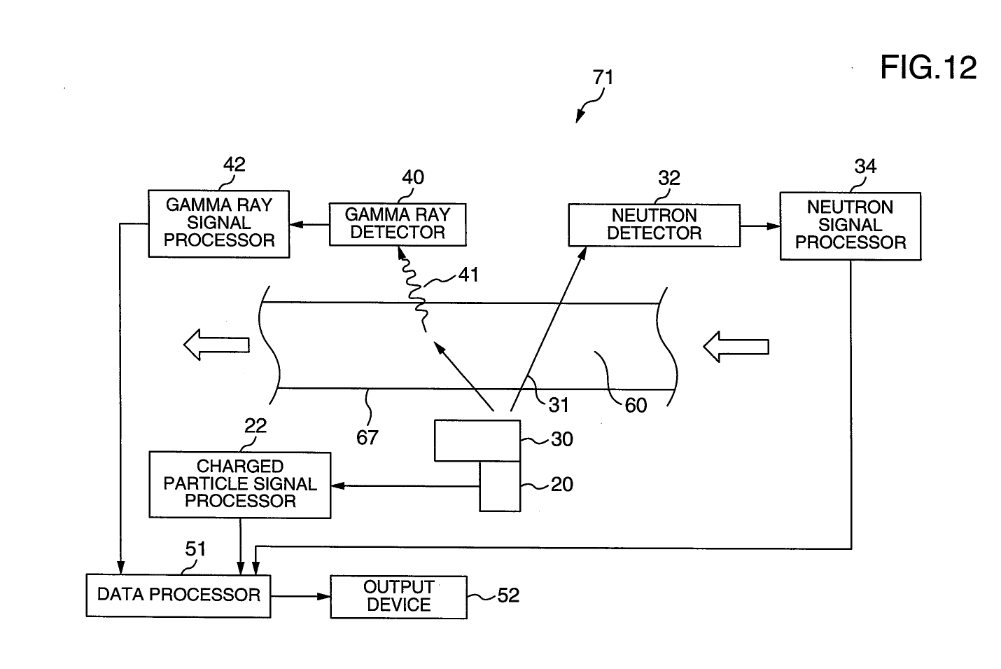

FIG. 12 shows a component analyzer 71 to analyze components or elements of an object in piping. In the analyzer 71, neutrons 31 generated from the neutron generator 30 are radiated onto an object 60 in the piping. Gamma rays are isotropically emitted from the object 60 as a result. By detecting the gamma rays, a value of energy of the gamma rays is obtained. According to the energy value, constituent elements of the object are identified. The analyzer 71 includes a charged particle detector 20, a charged particle signal processor 22 to process signals from the detector 20, a neutron generator 30, a neutron detector 32, a neutron signal processor 34 to process signals from the neutron detector 32, a gamma ray detector 40 to detect gamma rays, a gamma ray signal processor 42 to process signals from the detector 40, a data processor 51 to process data from the processors 22 and 42, and an output device 52 to display results of the processing. The analyzer 71 also includes a controller, not shown, to supervise overall operation of the analyzer 71. By measuring the charged particles, it is possible to obtain data of gamma rays generated only when neutrons are radiated onto the inspection object 60 in the piping. Since the data contains relatively a small amount of noise, the period of detection time required to detect data can be reduced. By measuring a quantity of neutrons having passed through the piping, the quantity of water in the piping can be attained.

Description will now be given of an example of a nuclear material detecting apparatus including the charged particle detector 20 and the neutron generator 30.

FIG. 13 shows a nuclear material detecting apparatus 81. In the apparatus 81, neutrons are radiated onto an inspection object 60. As a result, fast neutrons are emitted from a nuclear material 68 in the object 60. By measuring the fast neutrons, the nuclear material is identified. The apparatus 81 includes a charged particle detector 20, a charged particle signal processor 22 to process signals from the detector 20, a neutron generator 30, a neutron detector array 33 to detect neutrons, a neutron signal processor 34 to process signals from the neutron detector array 33, a data processor 51 to process data from the processors 22 and 34, and an output device 53 to display results of the processing. The apparatus 81 also includes a controller, not shown, to supervise overall operation of the apparatus 81. The apparatus 71 includes a turntable 9 as shown in FIG. 13. The inspection object 60 is placed on the turntable 9. Neutrons are radiated onto the object 60 while the turntable 9 is rotating. By measuring the charged particles, it is possible to obtain data of neutrons generated only when neutrons are radiated onto the inspection object 60. Since the data is obtained with relatively a small amount of noise, the period of time required to detect data can be reduced.

It should be further understood by those skilled in the art that although the foregoing description has been made on embodiments of the invention, the invention is not limited thereto and various changes and modifications may be made without departing from the spirit of the invention and the scope of the appended claims.

1. A charged particle detector, comprising:
a metallic frame having one or more holes formed therein;
a light transmitting member fixed in each of the holes of the metallic frame;
an inorganic scintillation element mounted on a first side of the light transmitting member;
a light shield film on a surface of the inorganic scintillation element, and
a photodetector mounted on a second side of the light transmitting member opposite said first side,
wherein fluorescence generated by charged particles having entered the inorganic scintillation element is sent via the light transmitting member to the photodetector and is detected by the photodetector, and
inorganic scintillation element has a thickness substantially equal to a range for energy of alpha rays to be detected.

2. (canceled)

3. A charged particle detector according to claim, wherein the inorganic scintillation element has a thickness substantially equal to a range for energy of charged particles to be detected.

4. A charged particle detector according to claim 1, wherein:
the light transmitting members and the inorganic scintillation elements are disposed in a contour of an array; and
the photodetector is arranged opposing the inorganic scintillation elements with the metallic frame between the photodetector and the elements.

5. A detector according to claim 1, including a neutron generator and a charged particle beam detector disposed at a side of the neutron generator, wherein the charged particle beam detector comprises:
a metallic frame having one or more holes formed therein;
a light transmitting member fixed in each of the holes of the metallic frame;
an inorganic scintillation element mounted on a first side of the light transmitting member;
a photodetector mounted on a second side of the light transmitting member opposite said first side, wherein fluorescence generated by charged particles having entered the inorganic scintillation element is sent via the light transmitting member to the photodetector and is detected by the photodetector; and
wherein each of the holes formed on the metallic frame has a cross-sectional contour of a trapezoid, the side of the smaller end of the holes formed on the metallic frame is disposed to face the neutron generator at vacuum, and the side of a larger end surface of the holes formed on the metallic frame is disposed to face the charged particle detector at atmospheric pressure.

6. A charged particle detector according to claim 1, wherein each of the holes has a contour of a cylinder or a regular prism.

7-8. (canceled)

9. A charged particle detector according to claim 1, wherein the photodetector is a photoelectric multiplier.

10. A detecting apparatus, comprising:
a charged particle detector, comprising:
a metallic frame having one or more holes formed therein;
a light transmitting member fixed in each of the holes of the metallic frame;
an inorganic scintillation element mounted on a first side the light transmitting member;
said inorganic scintillation element has a thickness substantially equal to a range for energy of alpha rays to be detected;
a photodetector mounted on a second side of the light transmitting member opposite said first side;
a light shield film on a surface of the inorganic scintillation element,
a neutron generator for generating charged particles and neutrons; and
a gamma ray detector for detecting gamma rays emitted when the neutrons are radiated onto an inspection object, wherein
according to a result of detection by the charged particle detector and a result of detection by the gamma ray detector, elements of the inspection object are identified and thereby detecting an explosive.

11. A detecting apparatus according to claim 10, the light transmitting member is coupled via a vacuum barrier with the photodetector.

12. A detecting apparatus according to claim 10, further comprising a measuring device for measuring a position and a contour of the inspection object before the neutrons are radiated onto the inspection object.

13. A detecting apparatus according to claim 10, further comprising an x-ray device for measuring a contour of the inspection object,
the x-ray device being arranged on a plane substantially vertical to a transport direction in which the inspection object is transported,
the x-ray device and the neutron generator existing on the plane.

14. A detecting apparatus according to claim 1, wherein the fused junction is formed of the light transmitting member disposed in each of said holes, said light transmitting member is glass having a softening point of about 800° C.

15. A detecting apparatus according to claim 14, wherein said linear expansion coefficient is equal over a range of the room temperature to the softening point.

16. A detecting apparatus according to claim 1, further comprising an insulator plate in front of the light transmitting member.

17. A detecting apparatus according to claim 16, wherein
the insulator plate is between the photodetector and the light transmitting member.

18. A charged particle detector according to claim 1,
wherein the metallic frame is equal in a linear expansion coefficient to the light transmitting member, the metallic frame being fixedly attached onto the light transmitting member by fused junction.

19. A detecting apparatus according to claim 10,
wherein the metallic frame is equal in a linear expansion coefficient to the light transmitting member, the metallic frame being fixedly attached onto the light transmitting member by fused junction.
